(19) United States
(12) Patent Application Publication
(10) Pub. No.: US 2026/0219762 A1
(43) Pub. Date: Jul. 30, 2026

(54) INTERACTION METHOD AND APPARATUS, ELECTRONIC DEVICE AND STORAGE MEDIUM

(71) Applicant: Beijing Zitiao Network Technology Co., Ltd., Haidian District, Beijing (CN)

(72) Inventor: Youjia SHEN, Beijing (CN)

(21) Appl. No.: 19/144,790

(22) PCT Filed: Dec. 15, 2023
(86) PCT No.: PCT/CN2023/139072

§ 371 Date: Jun. 30, 2025

(30) Foreign Application Priority Data
Dec. 29, 2022 (CN) 202211715627.6

(51) Int. Cl. G06F 3/0482

(52) U.S. Cl. CPC G06F 3/0482

(57) ABSTRACT

Embodiments of the present disclosure provide an interaction method, an interaction apparatus, an electronic device and a storage medium. The method includes: receiving a target state switching operation, wherein the target state switching operation serves as a state switching operation currently received, the state switching operation is used to switching a media content within a set from a first state to a second state, and different state switching operations correspond to different sets; switching, in response to the target state switching operation, a media content within a first set from the first state to the second state, wherein the first set is a set corresponding to the target state switching operation, and the media content in the first state and the media content in the second state have different media content presentations.

The present application claims the priority to Chinese patent application No. 202211715627.6, filed on Dec. 29, 2022, the entire disclosure of which is incorporated herein by reference in its entirety as a part of the present application.

### TECHNICAL FIELD

Embodiments of the present disclosure relate to an interaction method, an interaction apparatus, an electronic device and a storage medium.

### BACKGROUND

In some applications, the media content can have different presentation states. However, the way to switch the presentation states of the media content is relatively simple.

### SUMMARY

The embodiments of the present disclosure provide an interaction method, an interaction apparatus, an electronic device and a storage medium, so as to enrich the switching modes of the presentation state of the media content.

In a first aspect, an embodiment of the present disclosure provides an interaction method, which includes:
receiving a target state switching operation of a current user, wherein the target state switching operation serves as a state switching operation currently received, the state switching operation is used to switching a media content within a preset range from a first state to a second state, and different state switching operations correspond to different preset ranges;
switching, in response to the target state switching operation, a media content within a target preset range from the first state to the second state, wherein the target preset range is a preset range corresponding to the target state switching operation, and the media content in the first state and the media content in the second state have different media content presentation styles.

In a second aspect, the embodiment of the present disclosure also provides an interaction apparatus, which includes:
an operation receiving module, configured to receive a target state switching operation of a current user, wherein the target state switching operation serves as a state switching operation currently received, the state switching operation is used to switching a media content within a preset range from a first state to a second state, and different state switching operations correspond to different preset ranges; and
a state switching module, configured to switch, in response to the target state switching operation, a media content within a target preset range from the first state to the second state, wherein the target preset range is a preset range corresponding to the target state switching operation, and the media content in the first state and the media content in the second state have different media content presentation styles.

In a third aspect, an embodiment of the present disclosure also provides an electronic device, which includes:
one or more processors;
a memory for storing one or more programs,
when the one or more programs are executed by the one or more processors, the one or more processors realize the interaction method according to the embodiment of the present disclosure.

In a fourth aspect, the embodiment of the present disclosure also provides a computer-readable storage medium, on which a computer program is stored, which, when executed by a processor, realizes the interaction method described in the embodiment of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flowchart of an interaction method provided by an embodiment of the present disclosure;

FIG. 2 is a schematic diagram presenting a media content picture provided by an embodiment of the present disclosure;

FIG. 3 is a flowchart of another interaction method provided by an embodiment of the present disclosure;

FIG. 4 is a schematic diagram presenting another media content picture provided by an embodiment of the present disclosure;

FIG. 5 is a structural block diagram of an interaction apparatus provided by an embodiment of the present disclosure; and

FIG. 6 is a schematic structural diagram of an electronic device provided by an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between multiple apparatuses in the embodiments of the present disclosure are illustrative and not to limit the scope of the messages or information.

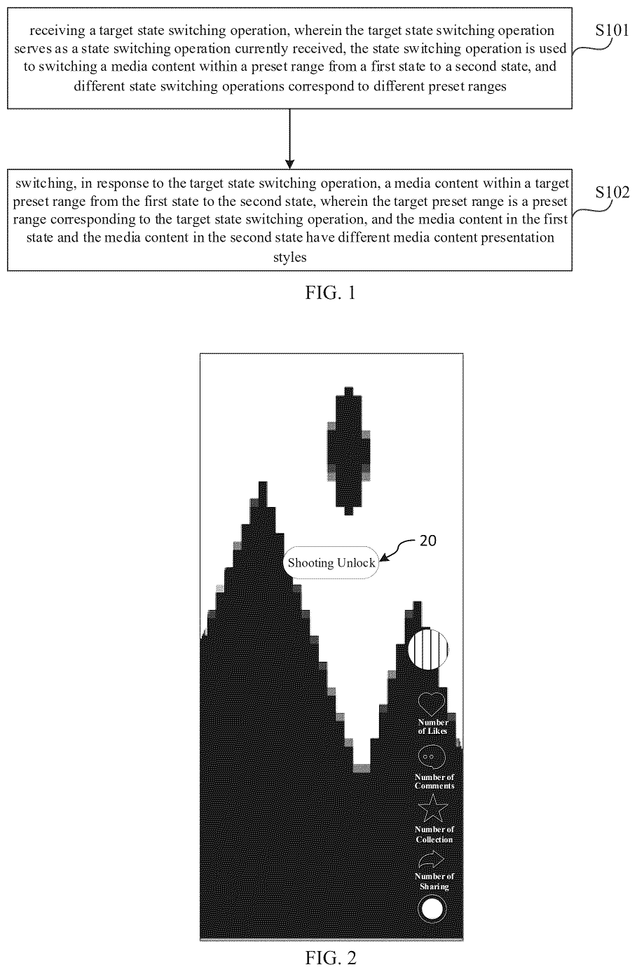

FIG. 1 is a flowchart of an interaction method provided by an embodiment of the present disclosure. The method can be executed by an interaction apparatus, wherein the apparatus can be implemented by software and/or hardware and can be configured in an electronic device, typically, in a mobile phone or a laptop computer. The interaction method provided by the embodiment of the present disclosure is applicable to the scenes where the presentation states of the media content in different ranges are switched through different trigger operations. As illustrated in FIG. 1, the interaction method provided by the present embodiment can include. As illustrated in FIG. 1, the method in the present embodiment can specifically include:
S101: receiving a target state switching operation, wherein the target state switching operation serves as a state switching operation currently received, the state switching operation is used to switching a media content within a preset range from a first state to a second state, and different state switching operations correspond to different preset ranges.

In the present embodiment, when the current user wants to switch the media content in the first state within a preset range to the second state, the target state switching operation corresponding to the preset range can be performed. Accordingly, the current application program can receive the target state switching operation performed by the current user.

The target state switching operation can be a state switching operation currently received. The state switching operation can be used to instruct switching the media content within the preset range from the first state to the second state. Illustratively, the state switching operation can include a trigger operation of releasing a preset media content, a preset interaction operation of a preset media content, or a trigger operation of establishing a preset association relationship with a preset number of other users. The preset media content can be a media content having a first state and a second state, such as a media content released by a publisher in a preset way; and the media content can be presented in a media content stream. Illustratively, the media content stream can include a plurality of released media contents pushed by the platform. The preset media content can be a video, a picture and/or a graphic content, etc., and the present embodiment does not limit the types of the preset media content. The preset interaction operation can be, for example, liking or commenting on a preset media content in the first state, or sharing a media content in the first state, or sending session information to the publisher of the media content in the first state, etc. The preset association relationship can be, for example, a following relationship, etc.

Different state switching operations correspond to different preset ranges, in other words, different state switching operations can be used to switch the media contents in different ranges from the first state to the second state. Optionally, the preset range includes a time range and/or a media content range. For example, different state switching operations can be used to switch at least part of the media content in the first state to the second state within different time ranges; and/or different state switching operations can be used to switch media contents in the first state within different media content ranges to the second state.

Illustratively, the first presentation style corresponding to the first state is a fuzzy presentation style, and the second presentation style corresponding to the second state is a clear presentation style. Different state switching operations correspond to different preset ranges, meaning that different state switching operations can unlock media contents in different ranges from the fuzzy presentation state to the clear presentation state.

The time range can be a time range for switching the media content in the first state to the second state. For example, when a certain state switching operation is received, at least part of the media content in the first state can be switched to the second state within a time range corresponding to the state switching operation. When it goes beyond the time range, the media content that has been switched to the second state based on the state switching operation can be switched back to the first state again; or, when it goes beyond the time range, the media content that has been switched to the second state based on the state switching operation maintains the display of the second state, while the newly released media content beyond the time range is presented in the first state.

In some embodiments, the time range includes at least one of a preset switching duration, a preset switching time period and a preset switching cycle, and the preset switching duration takes a time point when the corresponding state switching operation is received as a reference point.

The preset switching duration can be a predetermined time length for switching the media content in the first state to the second state, and when it goes beyond the time length, the corresponding media content can be switched back to the first state again or kept in the second state. The preset switching duration corresponding to a certain state switching operation (e.g., the target state switching operation) can takes the time point when the state switching operation is received as a reference point, for example, the time point when the state switching operation is received is taken as a starting time point or a certain n-section time point (n is a positive integer), and so on. Optionally, a time point corresponding to a first time duration after the reference point is the ending time point; the preset range includes a time range from a time point corresponding to a second duration before the ending time point to the ending time point. Here, the first duration and the second duration can be set as needed, and for example, the second duration is greater than, equal to or less than the second duration.

Assuming that the absolute value of the difference between the first duration and the second duration is a target duration, in the case where the second duration is greater than the first duration, when the corresponding state switching operation is received, a time point corresponding to the target duration before the state switching operation is received can be taken as the starting time point, a time point corresponding to the first duration after the state switching operation is received can be taken as the ending time point, and the state switching operation can be used to instruct switching at least part of the media content in the first state from the first state to the first state within the second duration between the starting time point and the ending time point. In the case where the second duration is equal to the first duration, the state switching operation can be used to instruct switching at least part of the media content in the first state from the first state to the second state within the second duration with a time point when the state switching operation is received as the starting time point. In the case where the second duration is less than the first duration, when the state switching operation is received, a time point corresponding to the target duration after the state switching operation is received can be taken as the starting time point, a time point corresponding to the first duration after the state switching operation is received as the ending time point, and the state switching operation can be used to instruct switching at least part of the media content in the first state from the first state to the first state within the second duration between the starting time point and the ending time point.

The preset switching time period can be a predetermined time period for switching the media content in the first state to the second state, which can be set as needed; for example, the preset switching time period can be set to 18:00-19:00 every day, Monday every week or the 20th every month, and so on. In this case, when it reaches the preset switching time period, at least part of the media content in the first state can be switched to the second state; when it goes beyond the preset switching time period, the corresponding media content can be switched back to the first state or kept in the second state.

The preset switching cycle can be a predetermined switching cycle, for example, one day, one week or one month, etc., can be taken as a switching cycle. In this case, illustratively, the state switching operation can be used to instruct switching at least part of the media content in the first state to the second state within the current preset switching period; when the current preset switching cycle ends, the corresponding media content can be switched back to the first state again or kept in the second state.

The media content range can be a range of the media content switched from the first state to the second state. For example, when a certain state switching operation is received, the media content in the first state within a media content range corresponding to the state switching operation can be switched to the second state, while the media content in the first state located outside the media content range is not switched to the second state. For example, a specific media content in the first state, a media content in the first state released by a specific publisher, and/or a media content in the first state that the current user has viewing permissions for, etc., can be switched to the second state.

Optionally, the state switching operation is applied to a target media content, the media content range includes a media content released by a target publisher in a current application or the target media content, and the target publisher is a publisher of the target media content.

For example, when a certain state switching operation (e.g., target state switching operation) is applied to a certain media content, the state switching operation can be used to instruct switching the media content from the first state to the second state, or to instruct switching at least one media content in the first state released by the publisher of the media content from the first state to the second state, and so on. The target media content can be a media content to which the state switching operation is applied. The target publisher can be the publisher of the target media content.

The media content to which a certain switching operation is applied can be, for example, a media content in the first state watched by the current user when performing the state switching operation.

For example, when the current user watches a certain media content in the first state, a trigger operation used to instruct releasing the preset media content can be performed, for example, a shooting page is entered by triggering a shooting control 20 (as illustrated in FIG. 2) displayed in the media content presentation page, a media content is shot on the shooting page, and the media content is released as the preset media content; or, a preset interaction operation for the media content can be performed, such as liking commenting on or sharing the media content, or sending session information to the publisher of the media content, etc.; or, a relationship establishment operation can be performed n times on the media content presentation page, for example, a following relationship is established with n other users who have not be followed. In this case, the media content in the first state that the current user is watching when performing the state switching operation can be taken as the target media content. Here, n is a positive integer and can be set as needed, for example, it can be set to a numerical value, such as 1 or 3, etc.

It can be understood that the current user can also perform the state switching operation through a page other than the media content presentation page, in other words, the user can also perform the state switching operation when not watching the media content in the first state, such as performing the state switching operation through a corresponding control displayed in a message list page or a personal page. In this case, the state switching operation may not have a corresponding target media content.
S102: switching, in response to the target state switching operation, a media content within a target preset range from the first state to the second state, wherein the target preset range is a preset range corresponding to the target state switching operation, and the media content in the first state and the media content in the second state have different media content presentation styles.

The first state and the second state can be two different states of the media content. Illustratively, the media content in the first state and the media content in the second state can have different media content presentation styles. For example, when presentation is needed, different media content presentation styles can be adopted to present the media content in the first state and the media content in the second state. The target preset range can be a preset range corresponding to the target state switching operation.

Specifically, when the target state switching operation of the current user is received, the target preset range corresponding to the target state switching operation can be determined according to the target state switching operation, and the media content in the first state within the target preset range can be switched from the first state to the second state.

For example, the current user can switch each media content in the first state that the current user has viewing permissions for from the first state to the second state within a certain time length (such as within the next 24 hours, etc.) by performing a preset media content releasing operation; and the current user can switch the target media content currently watched from the first state to the second state within a certain time length or for a long term by performing a state switching operation other than the preset media content releasing operation.

It can be understood that if the current user is watching a certain media content (e.g., the target media content) in the first state within the target preset range when switching the target media content from the first state to the second state, that is, the current application program is presenting a certain media content in the first state within the target preset range, then the presentation style of the media content will also change when switching the media content from the first state to the second state; for example, the media content picture of the media content currently presented is switched from the first presentation style corresponding to the first state to the second presentation style corresponding to the second state. In addition, switching the media content within the target preset range from the first state to the second state is only for the current user, and it will not affect the state of the media content when other users watch the corresponding media content.

According to the interaction method provided by the present embodiment, a target state switching operation of the current user is received, the target state switching operation serves as a state switching operation currently received, the state switching operation is used to switching a media content within a preset range from a first state to a second state, and different state switching operations correspond to different preset ranges; in response to the target state switching operation, a media content within a target preset range is switched from the first state to the second state, wherein the target preset range is a preset range corresponding to the target state switching operation, and the media content in the first state and the media content in the second state have different media content presentation styles. In the present embodiment, by adopting the above technical solution, the media contents within different preset ranges are switched from the first state to the second state based on different state switching operations of the user, which can enrich the switching modes of the presentation state of the media content.

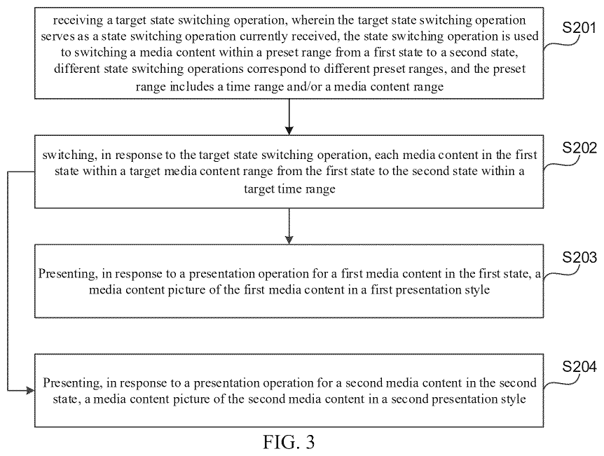

FIG. 3 is a flowchart of another interaction method provided by an embodiment of the present disclosure. The solution in the present embodiment can be combined with one or more optional solutions in the above embodiment. Optionally, the switching a media content within a target preset range from the first state to the second state includes: switching each media content in the first state within a target media content range from the first state to the second state within a target time range.

Optionally, the interaction method provided by the present embodiment further includes at least one of the following: presenting, in response to a presentation operation for a first media content in the first state, a media content picture of the first media content in a first presentation style; presenting, in response to a presentation operation for a second media content in the second state, a media content picture of the second media content in a second presentation style.

Accordingly, as illustrated in FIG. 3, the interaction method provided by the present embodiment can include:
S201: receiving a target state switching operation, wherein the target state switching operation serves as a state switching operation currently received, the state switching operation is used to switching a media content within a preset range from a first state to a second state, different state switching operations correspond to different preset ranges, and the preset range includes a time range and/or a media content range.

S202: switching, in response to the target state switching operation, each media content in the first state within a target media content range from the first state to the second state within a target time range, and performing S203 or S204, wherein the target preset range is a preset range corresponding to the target state switching operation, and the media content in the first state and the media content in the second state have different media content presentation styles.

In the present embodiment, when a target state switching operation of the current user is received, the media content in the first state within the target media content range can be switched from the first state to the second state within the target time range in response to the target state switching operation. The target time range can be understood as a time range corresponding to the target state switching operation; the target media content range can be understood as a media content range corresponding to the target state switching operation.

S203: Presenting, in response to a presentation operation for a first media content in the first state, a media content picture of the first media content in a first presentation style.

S204: Presenting, in response to a presentation operation for a second media content in the second state, a media content picture of the second media content in a second presentation style.

The presentation operation can be an operation used to instruct presenting a media content, and the media content can be a media content in the first state or a media content in the second state. The first media content can be considered as a media content in the first state to which the presentation operation is applied. The second media content can be considered as a media content in the second state to which the presentation operation is applied.

The first presentation style and the second presentation style can be two different presentation styles of the media content picture, and these two different presentation styles can be set as needed. For example, the first presentation style can be presenting the media content picture with a first resolution, and the second presentation style can be presenting the media content picture with a second resolution. The first resolution and the second resolution can be different resolutions. Illustratively, the second resolution can be the original resolution of the media content picture, that is, the original resolution when the media content is released; and the first resolution can be smaller than the second resolution.

Optionally, the first presentation style is a fuzzy presentation style, and the second presentation style is a clear presentation style. The fuzzy presentation style can be a presentation style of presenting the media content picture in a fuzzy way, and optionally, the picture presented in a fuzzy way can be obtained by blurring the original picture of the corresponding media content (e.g., the first media content). Illustratively, the current application program can blur the original media content picture of the media content in the first state directly or through a server; for example, mosaic or Gaussian blur, etc., can be added to at least some regions of the original media content picture in the presentation process, so as to obtain a media content picture with a fuzzy presentation style and to present this media content picture. The clear presentation style can be considered as a non-fuzzy presentation style. Illustratively, the clear presentation style can be a presentation style of presenting the original media content picture of the media content; for example, when the media content is in the second state, the original picture when it is released can be taken as a media content picture with a clear presentation style. Here, the original picture can be understood as the original media content picture of the media content, that is, the original picture of the media content released by the publisher of the media content.

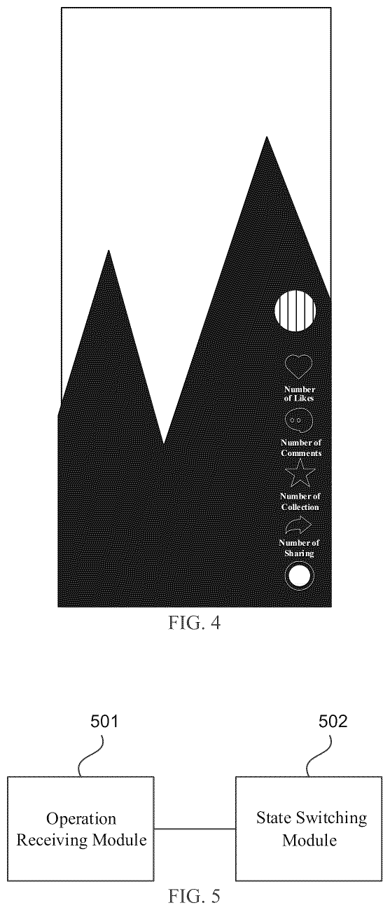

Illustratively, when a presentation operation for a certain media content in the first state (e.g., the first media content) is received, the media content picture of the media content can be presented in a first presentation style, for example, the media content picture of the media content can be presented in a fuzzy presentation style; in other words, the media content picture of the media content can be presented in a fuzzy presentation state, as shown in FIG. 2. And/or, when a presentation operation for a certain media content in the second state (e.g., the second media content), the media content picture of the media content can be presented in a second display style, for example, the media content picture of the media content can be presented in a clear presentation style; in other words, the media content picture of the media content can be presented in a clear presentation state, as shown in FIG. 4.

According to the interaction method provided by the present embodiment, based on different state switching operations of the user, the media contents in the first state within different media content ranges are switched to the second state within different time ranges; when a presentation operation for a media content in the first state is received, the media content corresponding to the presentation operation is presented in a first presentation style; when a presentation operation for a media content in the second state is received, the media content corresponding to the presentation operation is presented in a second display style, thus enriching the presentation styles of the media content and the switching modes of the presentation style of the media content.

FIG. 5 is a structural block diagram of an interaction apparatus provided by an embodiment of the present disclosure. The apparatus can be implemented by software and/or hardware, and can be configured in an electronic device, typically in a mobile phone or a tablet computer. And the apparatus can switch, by performing the interaction method, the presentation state of the media contents within different ranges based on different trigger operations of the user. As illustrated in FIG. 5, the interaction apparatus provided by the present embodiment can include: an operation receiving module 501 and a state switching module 502, wherein
the operation receiving module 501 is configured to receive a target state switching operation of a current user, the target state switching operation serves as a state switching operation currently received, the state switching operation is used to switching a media content within a preset range from a first state to a second state, and different state switching operations correspond to different preset ranges;
the state switching module 502 is configured to switch, in response to the target state switching operation, a media content within a target preset range from the first state to the second state, wherein the target preset range is a preset range corresponding to the target state switching operation, and the media content in the first state and the media content in the second state have different media content presentation styles.

According to the interaction apparatus provided by the present embodiment, a target state switching operation of the current user is received through an operation receiving module, the target state switching operation serves as a state switching operation currently received, the state switching operation is used to switching a media content within a preset range from a first state to a second state, and different state switching operations correspond to different preset ranges; in response to the target state switching operation, a media content within a target preset range is switched from the first state to the second state through a state switching module, wherein the target preset range is a preset range corresponding to the target state switching operation, and the media content in the first state and the media content in the second state have different media content presentation styles. In the present embodiment, by adopting the above technical solution, the media contents within different preset ranges are switched from the first state to the second state based on different state switching operations of the user, which can enrich the switching modes of the presentation state of the media content.

In the above solution, the preset range can include a time range and/or a media content range.

In the above solution, the time range can include at least one of a preset switching duration, a preset switching time period and a preset switching cycle, and the preset switching duration can take a time point when the corresponding state switching operation is received as a reference point.

In the above solution, a time point corresponding to a first duration after the reference point can be an ending time point; and the preset range can include a time range from a time point corresponding to a second duration before the ending time point to the ending time point.

In the above solution, the state switching operation can be applied to a target media content, the media content range can include a media content released by a target publisher in a current application or the target media content, and the target publisher is a publisher of the target media content.

In the above solution, the state switching module can be configured to: switch each media content in the first state within a target media content range from the first state to the second state within a target time range.

Further, the interaction apparatus provided by the present embodiment can include at least one of the following: a first presentation module, configured to present, in response to a presentation operation for a first media content in the first state, a media content picture of the first media content in a first presentation style; a second presentation module, configured to present, in response to a presentation operation for a second media content in the second state, a media content picture of the second media content in a second presentation style.

In the above solution, the first presentation style is a fuzzy presentation style, and the second presentation style is a clear presentation style.

The interaction apparatus provided by the embodiment of the present disclosure can perform the interaction method provided by any embodiment of the present disclosure, and has corresponding functional modules for executing the interaction method and corresponding beneficial effects. Technical details that are not fully described in the present embodiment may be referred to the interaction method provided by any embodiment of the present disclosure.

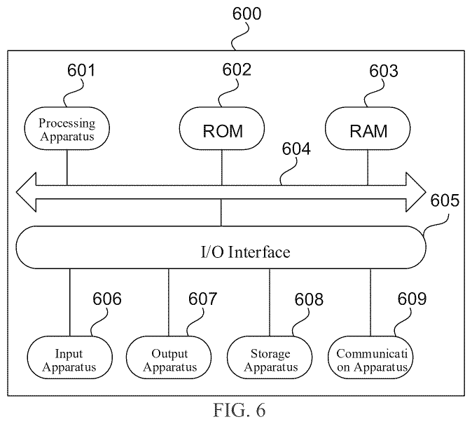

FIG. 6 is specifically referred below, and it shows the structure schematic diagram suitable for achieving the electronic device (for example, the terminal device) 600 in the embodiment of the present disclosure. The electronic device in the embodiment of the present disclosure may include but not be limited to a mobile terminal such as a mobile phone, a notebook computer, a digital broadcasting receiver, a personal digital assistant (PDA), a PAD (tablet computer), a portable multimedia player (PMP), a vehicle terminal (such as a vehicle navigation terminal), and a fixed terminal such as a digital television (TV) and a desktop computer. The electronic device shown in FIG. 6 is only an example and should not impose any limitations on the functions and use scopes of the embodiments of the present disclosure.

As shown in FIG. 6, the electronic device 600 may include a processing apparatus (such as a central processing unit, and a graphics processor) 601, it may execute various appropriate actions and processes according to a program stored in a read-only memory (ROM) 602 or a program loaded from a storage apparatus 608 to a random access memory (RAM) 603. In RAM 603, various programs and data required for operations of the electronic device 600 are also stored. The processing apparatus 601, ROM 602, and RAM 603 are connected to each other by a bus 604. An input/output (I/O) interface 605 is also connected to the bus 604.

Typically, the following apparatuses may be connected to the I/O interface 605: an input apparatus 606 such as a touch screen, a touchpad, a keyboard, a mouse, a camera, a microphone, an accelerometer, and a gyroscope; an output apparatus 607 such as a liquid crystal display (LCD), a loudspeaker, and a vibrator; a storage apparatus 608 such as a magnetic tape, and a hard disk drive; and a communication apparatus 609. The communication apparatus 609 may allow the electronic device 600 to wireless-communicate or wire-communicate with other devices so as to exchange data. Although FIG. 6 shows the electronic device 600 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 609, or installed from the storage apparatus 608, or installed from ROM 602. When the computer program is executed by the processing apparatus 601, the above functions defined in the embodiments of the present disclosure are executed.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above computer-readable medium can be contained in the above electronic device; and it can also exist separately without being assembled into the electronic device.

The above computer-readable medium carries one or more programs, and the above one or more programs, when executed by the electronic device, cause the electronic device to: receive a target state switching operation of a current user, wherein the target state switching operation serves as a state switching operation currently received, the state switching operation is used to switching a media content within a preset range from a first state to a second state, and different state switching operations correspond to different preset ranges; and switch, in response to the target state switching operation, a media content within a target preset range from the first state to the second state, wherein the target preset range is a preset range corresponding to the target state switching operation, and the media content in the first state and the media content in the second state have different media content presentation styles.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Herein, the name of the unit does not constitute a limitation for the unit itself in some cases.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

According to one or more embodiments of the present disclosure, Example 1 provides an interaction method, which includes:
receiving a target state switching operation of a current user, wherein the target state switching operation serves as a state switching operation currently received, the state switching operation is used to switching a media content within a preset range from a first state to a second state, and different state switching operations correspond to different preset ranges;
switching, in response to the target state switching operation, a media content within a target preset range from the first state to the second state, wherein the target preset range is a preset range corresponding to the target state switching operation, and the media content in the first state and the media content in the second state have different media content presentation styles.

According to one or more embodiments of the present disclosure, in Example 2 based on the method according to Example 1, the preset range includes a time range and/or a media content range.

According to one or more embodiments of the present disclosure, in Example 3 based on the method according to Example 2, the time range includes at least one of a preset switching duration, a preset switching time period and a preset switching cycle, and the preset switching duration takes a time point when the corresponding state switching operation is received as a reference point.

According to one or more embodiments of the present disclosure, in Example 4 based on the method according to Example 3, a time point corresponding to a first duration after the reference point is an ending time point; and the preset range includes a time range from a time point corresponding to a second duration before the ending time point to the ending time point.

According to one or more embodiments of the present disclosure, in Example 5 based on the method according to Example 2, the state switching operation is applied to a target media content, the media content range includes a media content released by a target publisher in a current application or the target media content, and the target publisher is a publisher of the target media content.

According to one or more embodiments of the present disclosure, in Example 6 based on the method according to Example 2, the switching a media content within a target preset range from the first state to the second state includes:
switching each media content in the first state within a target media content range from the first state to the second state within a target time range.

According to one or more embodiments of the present disclosure, in Example 7 based on the method according to any one of Examples 1-6, the method further includes at least one of the following:
presenting, in response to a presentation operation for a first media content in the first state, a media content picture of the first media content in a first presentation style;
presenting, in response to a presentation operation for a second media content in the second state, a media content picture of the second media content in a second presentation style.

According to one or more embodiments of the present disclosure, in Example 8 based on the method according to Example 7, the first presentation style is a fuzzy presentation style, and the second presentation style is a clear presentation style.

According to one or more embodiments of the present disclosure, Example 9 provides an interaction apparatus, which includes:
an operation receiving module, configured to receive a target state switching operation of a current user, wherein the target state switching operation serves as a state switching operation currently received, the state switching operation is used to switching a media content within a preset range from a first state to a second state, and different state switching operations correspond to different preset ranges; and
a state switching module, configured to switch, in response to the target state switching operation, a media content within a target preset range from the first state to the second state, wherein the target preset range is a preset range corresponding to the target state switching operation, and the media content in the first state and the media content in the second state have different media content presentation styles.

According to one or more embodiments of the present disclosure, Example 10 provides an electronic device, which includes:
one or more processors; and
a memory, configured to store one or more programs;
wherein the one or more programs, when executed by the one or more processors, cause the one or more processors to implement the interaction method according to any one of Examples 1-8.

According to one or more embodiments of the present disclosure, Example 11 provides a computer-readable storage medium, wherein a computer program is stored on the computer-readable storage medium, and the computer program, when executed by a processor, implements the interaction method according to any one of Examples 1-8.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An interaction method, comprising:
receiving a target state switching operation, the state switching operation is configured to switching a media content within a set from a first state to a second state, and different state switching operations correspond to different sets;
switching, in response to the target state switching operation, a media content within a first set from the first state to the second state, wherein the first set is a set corresponding to the target state switching operation, and the media content in the first state and the media content in the second state have different media content presentations.

2. The interaction method according to claim 1, wherein the set comprises a set associated with time or a set associated with media content.

3. The interaction method according to claim 2, wherein the set associated with time comprises at least one of a preset switching duration, a preset switching time period and a preset switching cycle, and the preset switching duration takes a time point when the corresponding state switching operation is received as a reference point.

4. The interaction method according to claim 3, wherein a time point corresponding to a first duration after the reference point is an ending time point; and the set comprises a time period from a time point corresponding to a second duration before the ending time point to the ending time point.

5. The interaction method according to claim 2, wherein the state switching operation is applied to a target media content, the set associated with media content comprises a media content released by a target publisher in a current application or the target media content, and the target publisher is a publisher of the target media content.

6. The interaction method according to claim 2, wherein the switching a media content within a first set from the first state to the second state comprises:
switching each media content in the first state within the set associated with media content from the first state to the second state within a target time period.

7. The interaction method according to claim 1, further comprising at least one of the following:
presenting, in response to a presentation operation for a first media content in the first state, a media content picture of the first media content in a first presentation style;
presenting, in response to a presentation operation for a second media content in the second state, a media content picture of the second media content in a second presentation style.

8. The interaction method according to claim 7, wherein the first presentation style is a fuzzy presentation style, and the second presentation style is a clear presentation style.

9. (canceled)

10. An electronic device, comprising:
at least one processor; and
a memory in communicative connection with the at least one processor;
wherein a computer program executable by the at least one processor is stored on the memory, and the computer program is executed by the at least one processor to enable the at least one processor to perform an interaction method, which comprises:
receiving a target state switching operation, the state switching operation is configured to switching a media content within a set from a first state to a second state, and different state switching operations correspond to different sets;
switching, in response to the target state switching operation, a media content within a first set from the first state to the second state, wherein the first set is a set corresponding to the target state switching operation, and the media content in the first state and the media content in the second state have different media content presentations.

11. A non-transitory computer-readable storage medium, wherein computer instructions are stored on the computer-readable storage medium, and the computer instructions, when executed by a processor, are used to cause the processor to implement an interaction method, which comprises:
receiving a target state switching operation, the state switching operation is configured to switching a media content within a set from a first state to a second state, and different state switching operations correspond to different sets;
switching, in response to the target state switching operation, a media content within a first set from the first state to the second state, wherein the first set is a set corresponding to the target state switching operation, and the media content in the first state and the media content in the second state have different media content presentations.

12. The electronic device according to claim 10, wherein the set comprises a set associated with time or a set associated with media content.

13. The electronic device according to claim 12, wherein the set associated with time comprises at least one of a preset switching duration, a preset switching time period and a preset switching cycle, and the preset switching duration takes a time point when the corresponding state switching operation is received as a reference point.

14. The electronic device according to claim 13, wherein a time point corresponding to a first duration after the reference point is an ending time point; and the set comprises a time period from a time point corresponding to a second duration before the ending time point to the ending time point.

15. The electronic device according to claim 12, wherein the state switching operation is applied to a target media content, the set associated with media content comprises a media content released by a target publisher in a current application or the target media content, and the target publisher is a publisher of the target media content.

16. The electronic device according to claim 12, wherein the switching a media content within a first set from the first state to the second state comprises:
switching each media content in the first state within the set associated with media content from the first state to the second state within a target time period.

17. The electronic device according to claim 10, wherein the method further comprises at least one of the following:
presenting, in response to a presentation operation for a first media content in the first state, a media content picture of the first media content in a first presentation style;
presenting, in response to a presentation operation for a second media content in the second state, a media content picture of the second media content in a second presentation style.

18. The electronic device according to claim 17, wherein the first presentation style is a fuzzy presentation style, and the second presentation style is a clear presentation style.

19. The non-transitory computer-readable storage medium according to claim 11, wherein the set comprises a set associated with time or a set associated with media content.

20. The non-transitory computer-readable storage medium according to claim 19, wherein the time period comprises at least one of a preset switching duration, a preset switching time period and a preset switching cycle, and the preset switching duration takes a time point when the corresponding state switching operation is received as a reference point.

21. The non-transitory computer-readable storage medium according to claim 20, wherein a time point corresponding to a first duration after the reference point is an ending time point; and the set comprises a time period from a time point corresponding to a second duration before the ending time point to the ending time point.
